(19) United States
(12) Patent Application Publication
(10) Pub. No.: US 2015/0180695 A1
(43) Pub. Date: Jun. 25, 2015

(54) PREAMBLE DETECTION DEVICE, PREAMBLE DETECTION METHOD AND COMPUTER PROGRAM

(71) Applicant: NEC Corporation, Tokyo (JP)

(72) Inventors: Akihisa Hashizume, Tokyo (JP); Masayuki Kimata, Tokyo (JP)

(21) Appl. No.: 14/411,742

(22) PCT Filed: Feb. 27, 2013
(86) PCT No.: PCT/JP2013/055098

§ 371 Date: Dec. 29, 2014

(30) Foreign Application Priority Data
Jun. 28, 2012 (JP) 2012-146024

(51) Int. Cl. H04L 27/26; H04W 72/04; H04L 5/00

(52) U.S. Cl. CPC H04L 27/2663; H04L 5/0044; H04W 72/0413; H04W 88/08

(57) ABSTRACT

Suppressed is occurrence of false preamble detection in a preamble detection device for detecting a preamble sequence which is sent to it by the use of a physical random access channel. A preamble detection device includes a first threshold calculation unit (203) for calculating a first threshold value from average interference power; a second threshold calculation unit (205) for calculating cross-correlation values between a received signal and respective ones of all preamble sequences possibly to be sent, and calculating a second threshold value from the cross-correlation values; a comparison unit (208) for comparing the first threshold value with the second threshold value, and setting the larger one of the threshold values to be a detection threshold value; and a detection unit (209) for detecting a preamble sequence giving a cross-correlation value larger than the detection threshold value as a received preamble sequence.

### TECHNICAL FIELD

The present invention relates to a preamble detection device, a preamble detection method and a computer program.

### BACKGROUND ART

Generally known is the LTE (Long Term Evolution) cellular system, which is a wireless communication method using an SC-FDMA (Single Carrier Frequency Division Multiple Access) scheme defined by 3GPP (Third Generation Partnership Project).

According to Non-patent Literature 1 (NPL 1), in an uplink random access procedure in the LTE cellular system, a terminal willing to start communication selects one preamble sequence from among a plurality of preamble sequences at random, and sends it to a wireless base station via a physical random access channel (PRACH).

The wireless base station is equipped with a “preamble detection device” which determines from a received signal whether or not a terminal has sent a preamble sequence, and a “wireless resource allocation device” which allocates a wireless resource to a terminal for which a preamble has been detected. The preamble detection device extracts a received signal allocated to a PRACH and performs peak detection based on a result on cross-correlation values between the received signal and known preamble sequences, and outputs the detection result to the wireless resource allocation device.

As a general preamble detection device, a configuration described in Non-patent Literature 2 (NPL 2) is known.

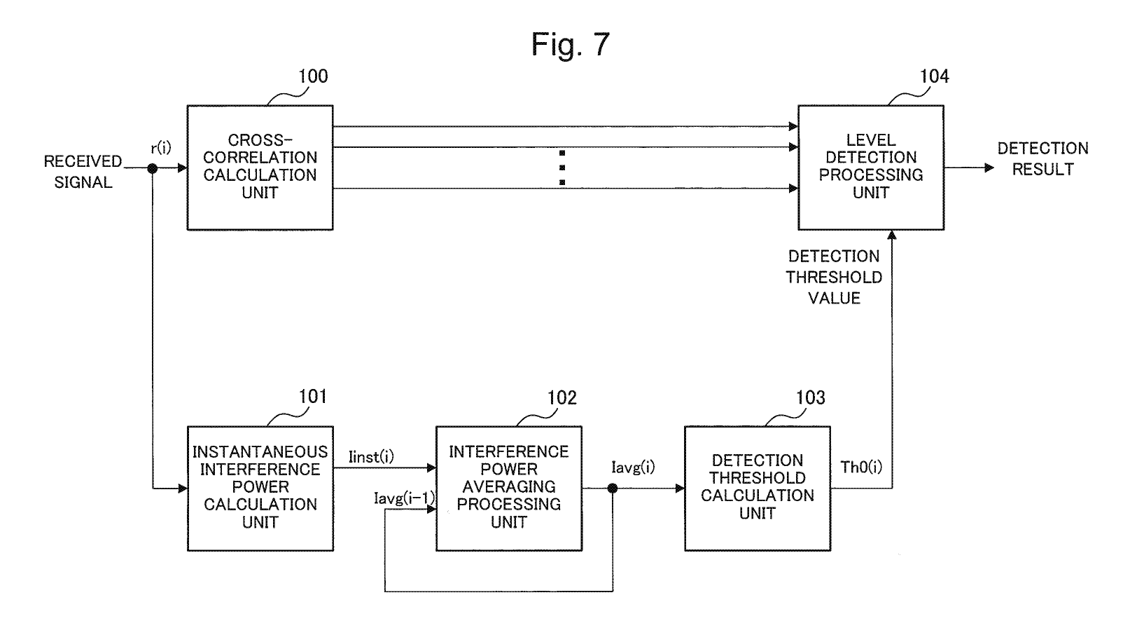

FIG. 7 shows a configuration of a conventional preamble detection device which performs peak detection, using a received signal as input. In FIG. 7, a received signal at a time i is expressed as r(i).

In FIG. 7, using the received signal r(i) as input, a cross-correlation calculation unit 100 calculates cross-correlation values between the received signal r(i) and respective ones of all preamble sequences possibly to be sent, and outputs the values to a level detection processing unit 104. An instantaneous interference power calculation unit 101 calculates an instantaneous interference power Iinst(i) at a time i, using the received signal r(i) as input, and outputs Iinst(i) to an interference power averaging processing unit 102. The interference power averaging processing unit 102 updates an average interference power Iavg(i), using the instantaneous interference power Iinst(i), which is an output of the instantaneous interference power calculation unit 101, and a previously calculated average interference power Iavg(i−1), and outputs the updated Iavg(i) to a detection threshold calculation unit 103. From the average interference power Iavg(i) outputted by the interference power averaging processing unit 102, the detection threshold calculation unit 103 calculates a detection threshold value Th0(i) by an equation (1) and outputs it to a level detection processing unit 104.

Th0(i)=C0−Iavg(i) (1)

Here, C0 is an adjustable internal parameter.

The level detection processing unit 104 compares outputs of the cross-correlation calculation unit 100 with the detection threshold Th0(i), thereby determines a preamble sequence giving an output larger than the detection threshold Th0(i) to be “detected”, and outputs the result to the wireless resource allocation device.

The cross-correlation calculation unit 100, the instantaneous interference power calculation unit 101 and the interference power averaging processing unit 102 are well known to those skilled in the art (for example, Patent Literature described below (PTL 1-4) is referred to), and therefore, description of their detailed configurations is omitted here.

As has been described above, in a conventional configuration, the determination process by a threshold value is performed using only a single preamble detection threshold which have been calculated from average interference power.

In that case, when a cross-correlation value between a received signal and a preamble sequence other than that sent by a terminal becomes larger than the detection threshold value Th0(i) owing to the reception state of the wireless base station at that time, the wireless resource allocation device falsely allocates a wireless resource to a nonexistent terminal, and as a result, the utilization efficiency of wireless resources is deteriorated. This event is referred to as false preamble detection.

In the configuration of a conventional preamble detection device, false preamble detection occurs in the following two reception conditions:
reception condition 1) a case where the power of a preamble transmission signal of a terminal is high and attenuation of the signal during radio-wave propagation is small;
receiving condition 2) a case where a high power interference signal exists for an instant.

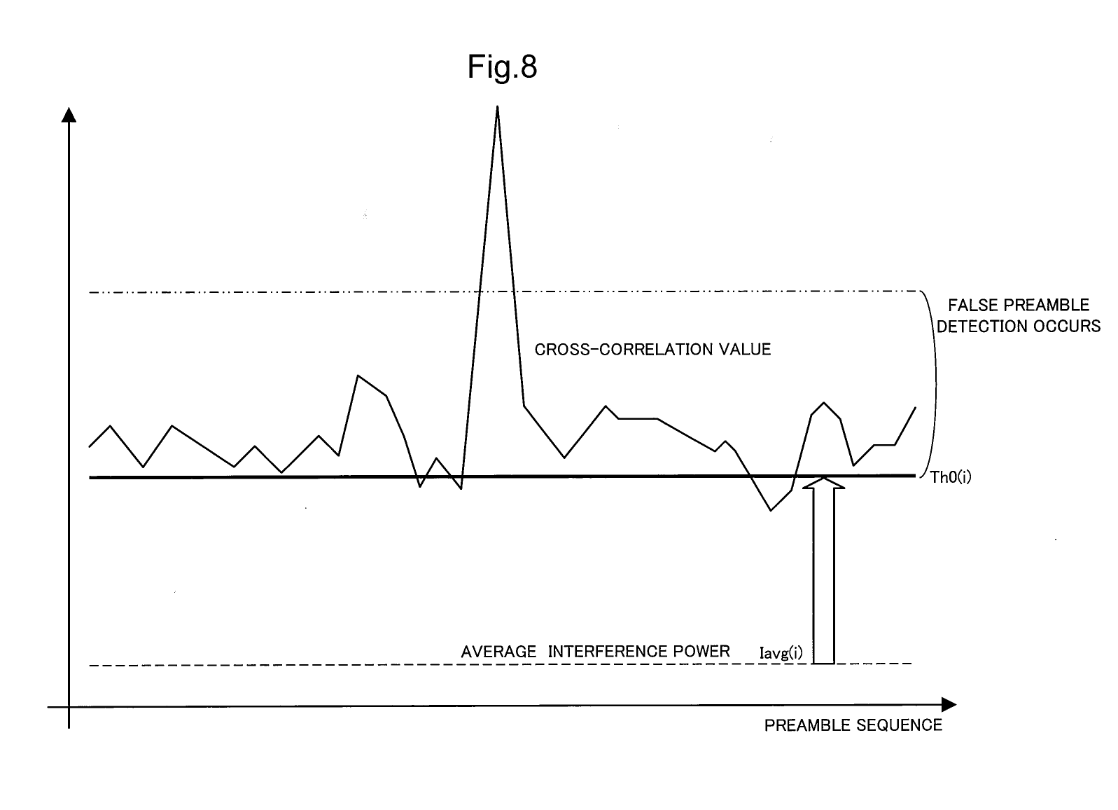

A description will be given below of preamble detection operation in the reception condition 1 performed in the conventional configuration, with reference to FIG. 8. FIG. 8 shows a relation between cross-correlation values and the detection threshold value. The horizontal axis represents preamble sequences, and the vertical axis does cross-correlation values.

Output of the cross-correlation calculation unit 100 becomes very high when it corresponds to a cross-correlation value with respect to a preamble sequence sent by a terminal. At that time, because received power is large, cross-correlation values with respect to other preamble sequences also become relatively large. On the other hand, because interference power shows almost no variation, the detection threshold value Th0(i) also varies very little. Accordingly, a cross-correlation value between the received signal and a preamble sequence other than that sent by the terminal becomes larger than the detection threshold value Th0(i), and as a result, false preamble detection occurs.

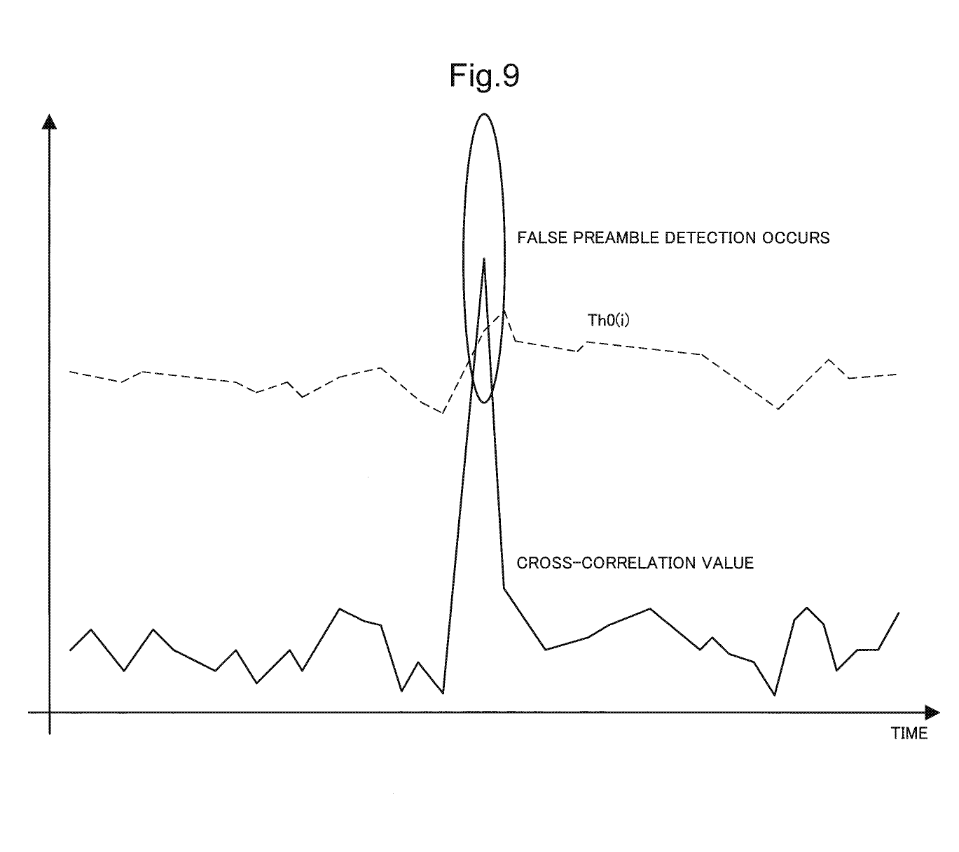

A description will be given below of preamble detection operation in the reception condition 2 performed in the conventional configuration, with reference to FIG. 9. FIG. 9 shows a relation between cross-correlation values and a detection threshold value. The horizontal axis represents time, and the vertical axis does cross-correlation values with respect to a certain preamble sequence.

It is assumed that the instantaneous interference power Iinst(i) becomes very high at a time i_F. At that time, because received power is high, cross-correlation values also become large. On the other hand, Iavg(i) shows smaller temporal variation than Iinst(i) does, by the effect of its being averaged in time, and accordingly, temporal variation of the detection threshold Th0(i) also is small. For this reason, a cross-correlation value becomes larger than the detection threshold Th0(i), and as a result, false preamble detection occurs.

### CITATION LIST

### Patent Literature

[PTL 1] Japanese Patent Application Laid-Open No. 2011-097506

[PTL 2] Japanese Patent Application Laid-Open No. 2011-114385

[PTL 3] Japanese Patent Application Laid-Open No. 2011-114716

[PTL 4] WO2009/057483

### Non Patent Literature

[NPL 1] 3GPP, “3GPP TS36.213 v8.8.0”, Sep. 2009

[NPL 2] 3GPP RANI #46bis, R1-062630, “Non-synchronized Random Access Structure for E-UTRA”, Oct. 2006

### SUMMARY OF INVENTION

### Technical Problem

As described above, in a conventional configuration, false preamble detection frequently occurs in the first and the second reception conditions.

In this respect, the objective of the present invention is to solve the above-described problem, that is, to provide a preamble detection device, a preamble detection method and a program which can suppress occurrence of false preamble detection.

### Solution to Problem

In order to solve the above-described problem, a first aspect of a preamble detection device of the present invention is a preamble detection device for detecting a preamble sequence sent by the use of a physical random access channel, which comprises: first threshold calculation means for calculating a first threshold value from average interference power; second threshold calculation means for calculating cross-correlation values between a received signal and respective ones of all preamble sequences possibly to be sent, and then calculating a second threshold value from the cross-correlation values; comparison means for comparing the first threshold value with the second threshold value, and then setting the larger one of the threshold values to be a detection threshold value; and detection means for detecting a preamble sequence giving a cross-correlation value larger than the detection threshold value as a received preamble sequence.

A first aspect of a preamble detection method of the present invention is a preamble detection method for detecting a preamble sequence sent by the use of a physical random access channel, which comprises: a step of calculating a first threshold value from average interference power; a step of calculating cross-correlation values between a received signal and respective ones of all preamble sequences possibly to be sent, and then calculating a second threshold value from the cross-correlation values; a step of comparing the first threshold value with the second threshold value, and then setting the larger one of the threshold values to be a detection threshold value; and a step of detecting a preamble sequence giving a cross-correlation value larger than the detection threshold value as a received preamble sequence.

A first aspect of a program of the present invention is a program for causing a computer, of a preamble detection device for detecting a preamble sequence sent by the use of a physical random access channel, to execute a process including: a step of calculating a first threshold value from average interference power; a step of calculating cross-correlation values between a received signal and respective ones of all preamble sequences possibly to be sent, and then calculating a second threshold value from the cross-correlation values; a step of comparing the first threshold value with the second threshold value, and then setting the larger one of the threshold values to be a detection threshold value; and a step of detecting a preamble sequence giving a cross-correlation value larger than the detection threshold value as a received preamble sequence.

Further, a second aspect of a preamble detection device of the present invention is a preamble detection device for detecting a preamble sequence sent by the use of a physical random access channel, which comprises: first threshold calculation means for calculating a first threshold value from average interference power; second threshold calculation means for calculating a second threshold value from instantaneous interference power and variance of interference power; comparison means for comparing the first threshold value with the second threshold value, and then setting the larger one of the threshold values to be a detection threshold value; and detection means for detecting a preamble sequence giving a cross-correlation value larger than the detection threshold value as a received preamble sequence.

Further, a second aspect of a preamble detection method of the present invention is a preamble detection method for detecting a preamble sequence sent by the use of a physical random access channel, which comprises: a step of calculating a first threshold value from average interference power; a step of calculating a second threshold value from instantaneous interference power and variance of interference power; a step of comparing the first threshold value with the second threshold value, and then setting the larger one of the threshold values to be a detection threshold value; and a step of detecting a preamble sequence giving a cross-correlation value larger than the detection threshold value as a received preamble sequence.

A second aspect of a program of the present invention is a program for causing a computer, of a preamble detection device for detecting a preamble sequence sent by the use of a physical random access channel, to execute a process including: a step of calculating a first threshold value from average interference power; a step of calculating a second threshold value from instantaneous interference power and variance of interference power; a step of comparing the first threshold value with the second threshold value, and then setting the larger one of the threshold values to be a detection threshold value; and a step of detecting a preamble sequence giving a cross-correlation value larger than the detection threshold value as a received preamble sequence.

### ADVANTAGEOUS EFFECTS OF INVENTION

According to the present invention, it is possible to provide a preamble detection device, a preamble detection method and a program which can suppress occurrence of false preamble detection.

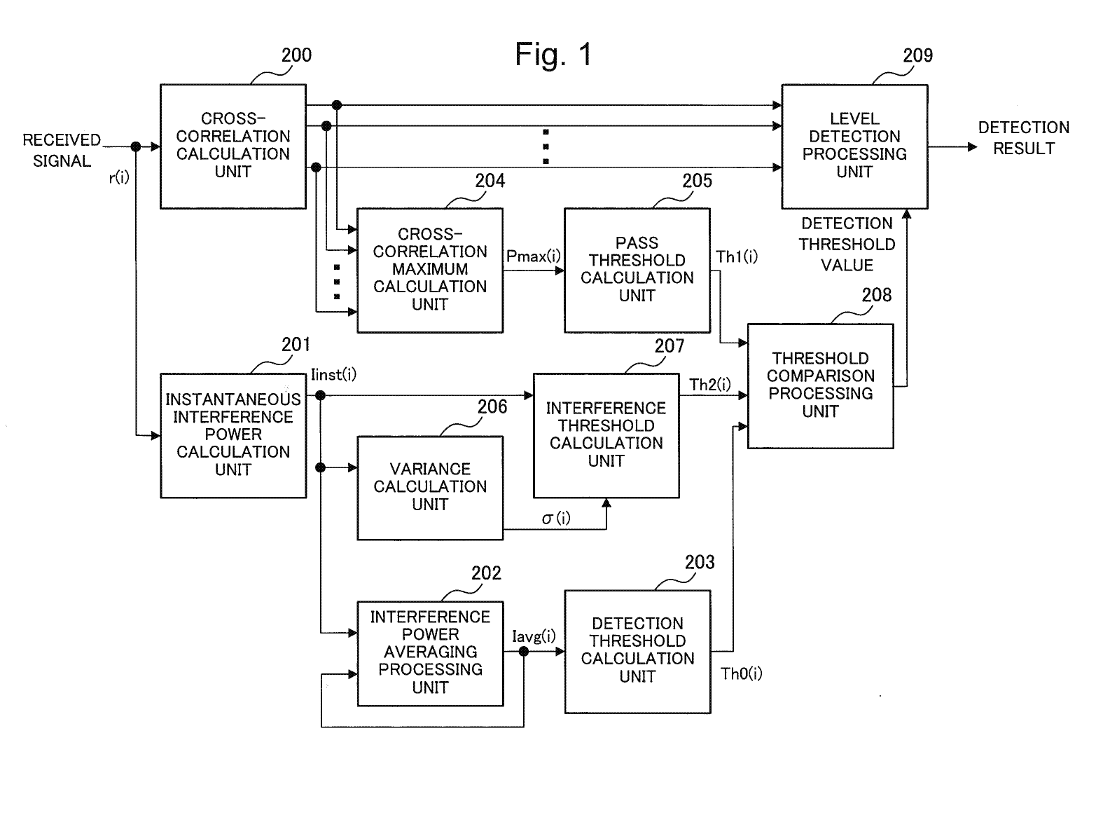

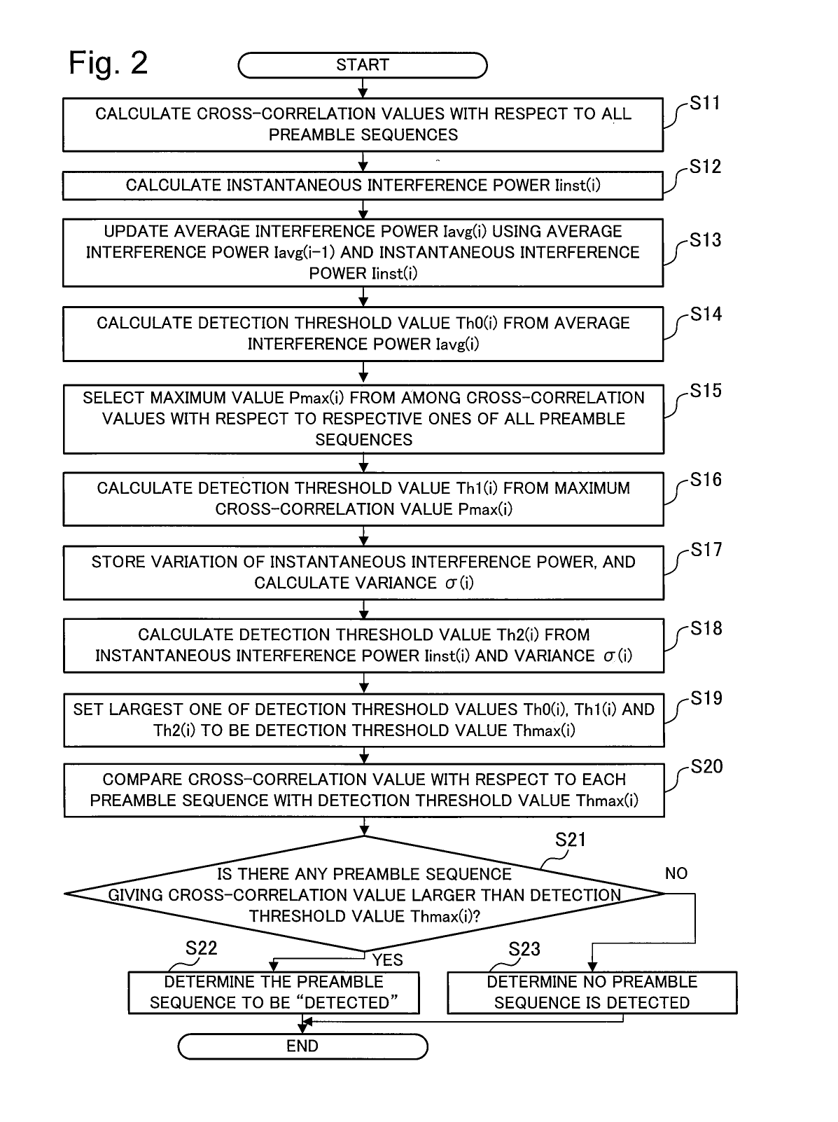

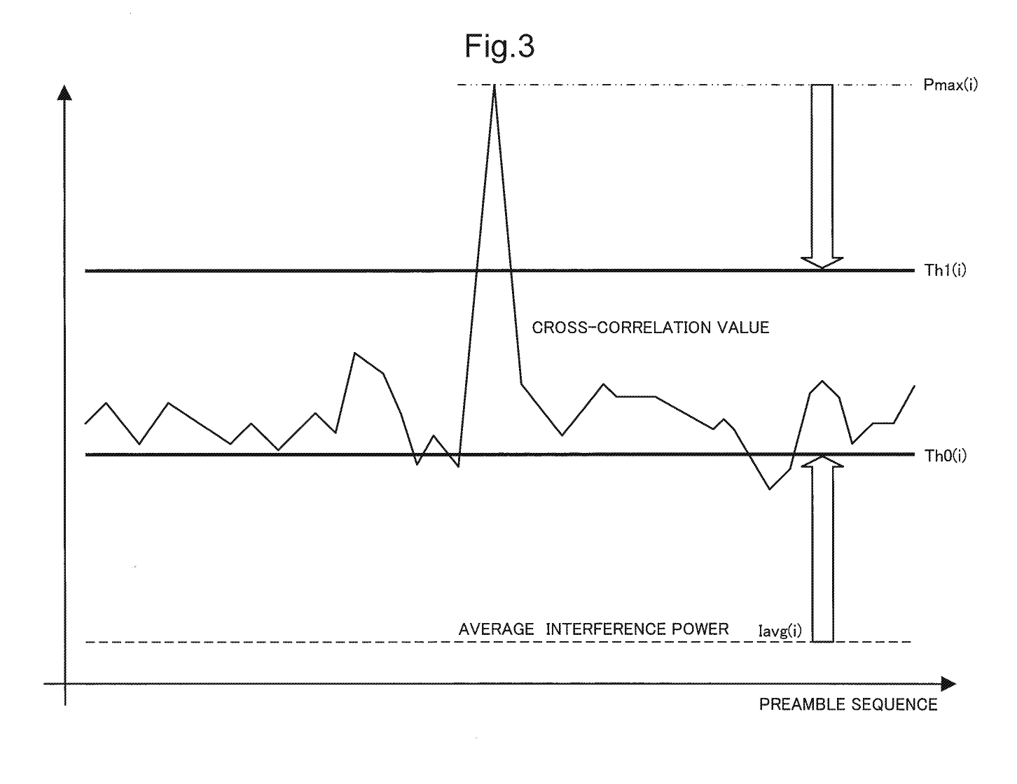

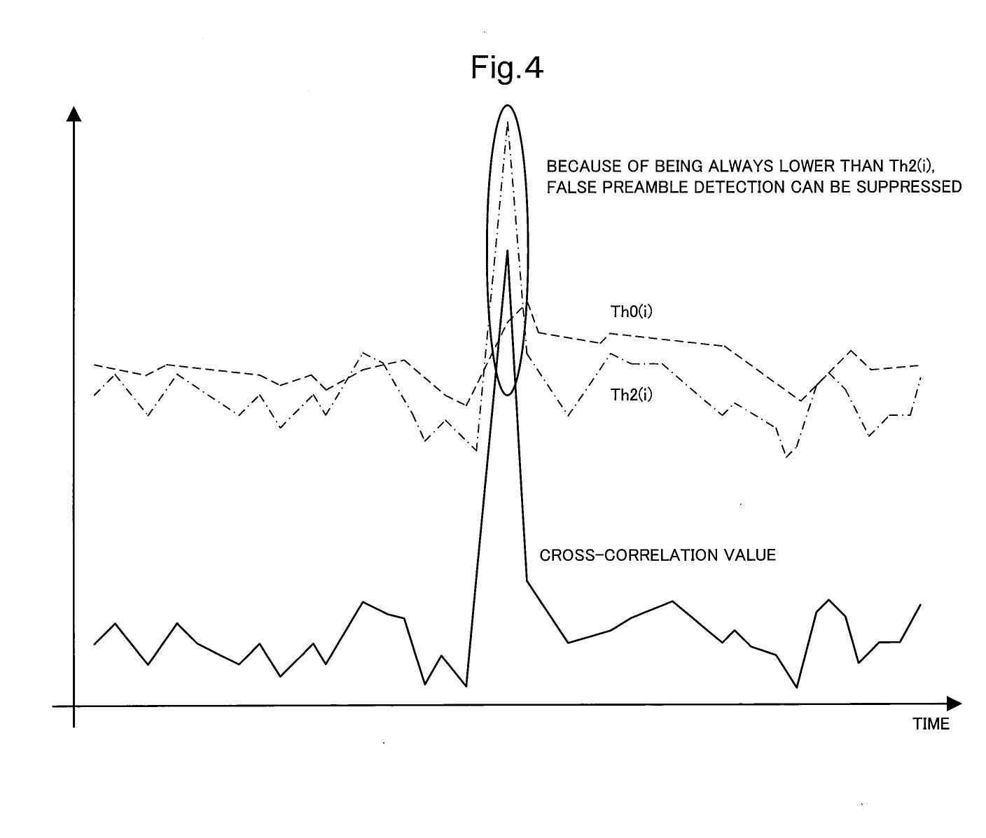

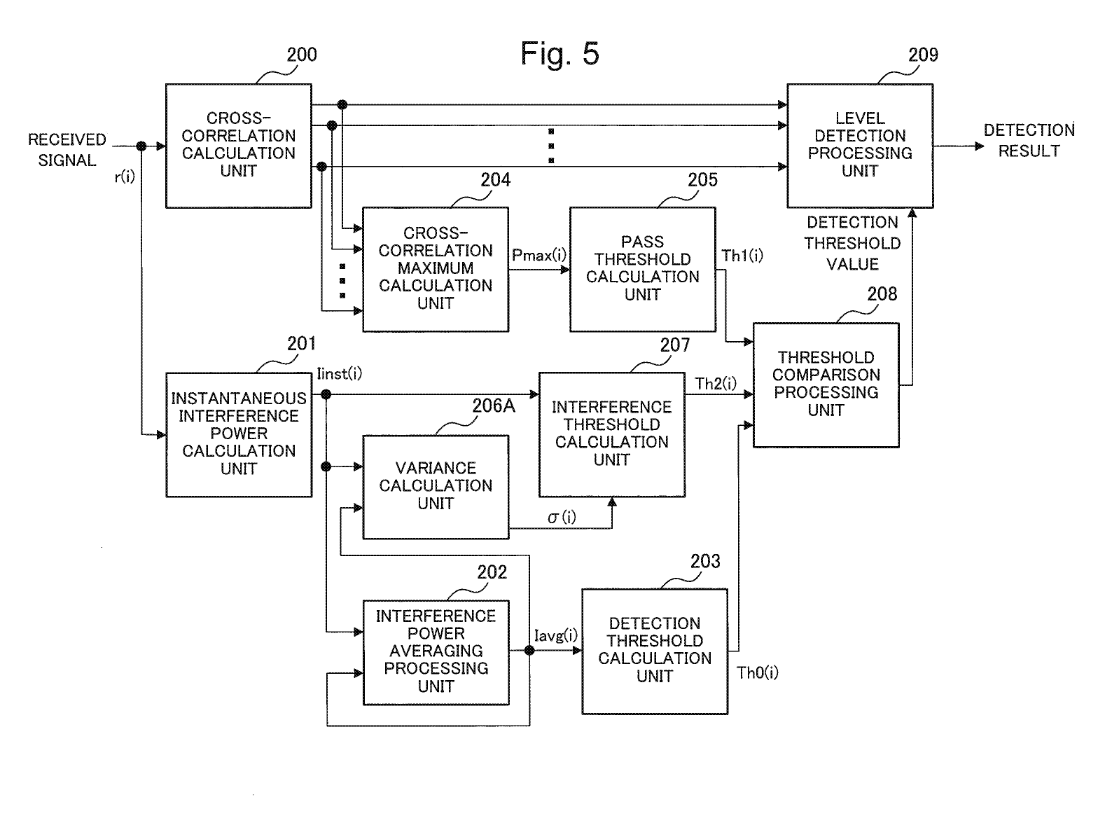

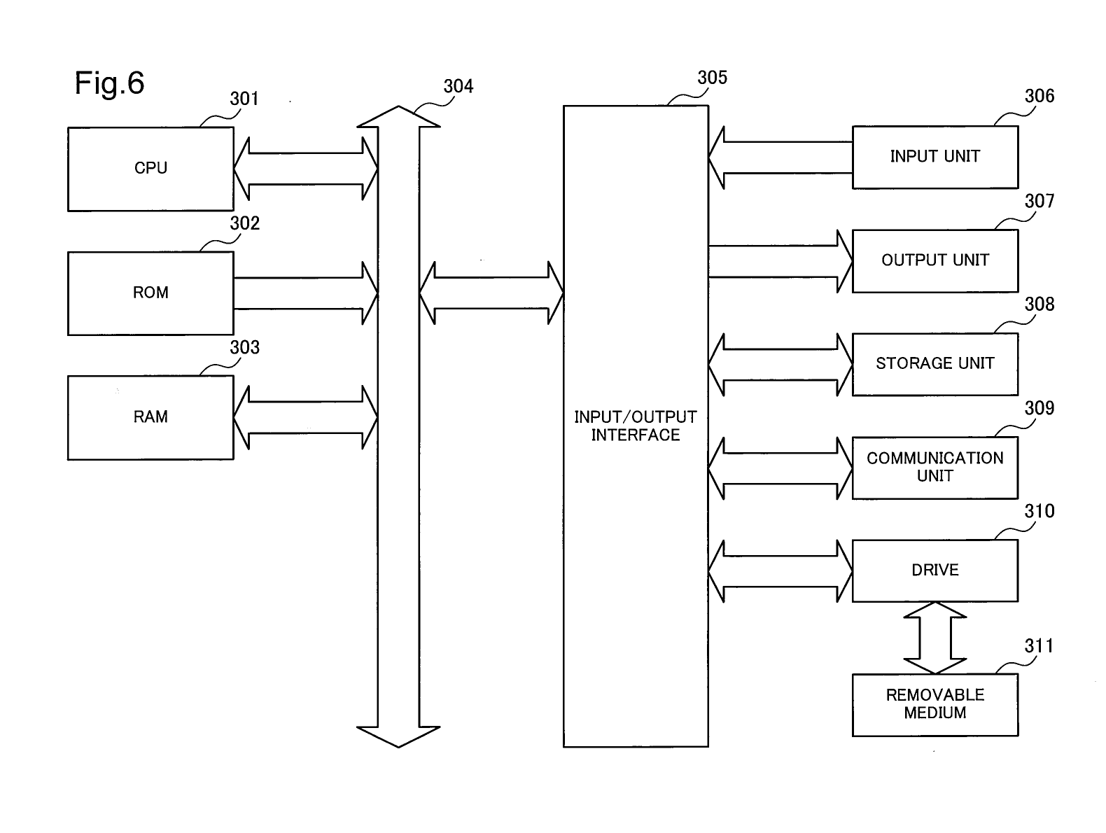

### BRIEF DESCRIPTION OF DRAWINGS

[FIG. 1] A block diagram showing an example of a configuration of a preamble detection device according to a first exemplary embodiment of the present invention

[FIG. 2] A flow chart illustrating a detection process

[FIG. 3] A diagram illustrating suppression of occurrence of false preamble detection

[FIG. 4] A diagram illustrating suppression of occurrence of false preamble detection

[FIG. 5] A block diagram showing an example of a configuration of a preamble detection device according to a second exemplary embodiment of the present invention

[FIG. 6] A block diagram showing an example of a hardware configuration of a computer

[FIG. 7] A block diagram showing a configuration of a conventional preamble detection device

[FIG. 8] A diagram illustrating preamble detection operation in a conventional configuration

[FIG. 9] A diagram illustrating preamble detection operation in a conventional configuration

### DESCRIPTION OF EMBODIMENTS

Hereinafter, exemplary embodiments of the present invention will be described with reference to drawings.

FIG. 1 is a block diagram showing an example of a configuration of a preamble detection device according to a first exemplary embodiment of the present invention. This preamble detection device is installed in a wireless base station, and comprises a cross-correlation calculation unit 200, an instantaneous interference power calculation unit 201, an interference power averaging processing unit 202, a detection threshold calculation unit 203, a cross-correlation maximum calculation unit 204, a pass threshold calculation unit 205, a variance calculation unit 206, an interference threshold calculation unit 207, a threshold comparison processing unit 208 and a level detection processing unit 209.

Using a received signal r(i) as input, the cross-correlation calculation unit 200 calculates cross-correlation values between the received signal r(i) and respective ones of all preamble sequences possibly to be sent, and outputs the calculated cross-correlation values to the cross-correlation maximum calculation unit 204 and the level detection processing unit 209. The instantaneous interference power calculation unit 201 calculates an instantaneous interference power Iinst(i), using the received signal r(i) as input, and outputs the calculated instantaneous interference power Iinst(i) to the interference power averaging processing unit 202, the variance calculation unit 206 and the interference threshold calculation unit 207.

The interference power averaging processing unit 202 updates an average interference power Iavg(i), using as input the instantaneous interference power Iinst(i), which is output of the instantaneous interference power calculation unit 201, and also an average interference power Iavg(i−1) which was previously calculated by the interference power averaging processing unit 202, and outputs the calculated average interference power Iavg(i) to the detection threshold calculation unit 203. The detection threshold calculation unit 203 constitutes a first threshold calculation means and calculates a detection threshold value Th0(i) by the equation (1) from the average interference power Iavg(i) outputted by the interference power averaging processing unit 202. Thus calculated detection threshold value Th0 (i) is outputted to the threshold comparison processing unit 208.

The cross-correlation maximum calculation unit 204 selects a maximum value Pmax(i) from among the cross-correlation values outputted from the cross-correlation calculation unit 200, and outputs it to the pass threshold calculation unit 205. The pass threshold calculation unit 205 constitutes a second threshold calculation means, and calculates a detection threshold value Th1(i) from the maximum cross-correlation value Pmax(i) outputted from the cross-correlation maximum calculation unit 204, and outputs the detection threshold value Th1(i) to the threshold comparison processing unit 208.

Th1(i)=C1−Pmax(i) (2)

Here, C1 is an adjustable internal parameter.

The variance calculation unit 206 calculates a variance value σ(i) by an equation (3) from variation of instantaneous interference power in the past N samples until a time i, and outputs the variance value σ(i) to the interference threshold calculation unit 207.

$$\begin{matrix}[ numerical formula 1 ] & \\ σ ( i ) = \frac{1}{N} {\sum }_{n = 0}^{N - 1} {( Iinst ( i - n ) - ( \frac{1}{N} {\sum }_{n = 0}^{N - 1} Iinst ( i - n ) ) )}^{2} & ( 3 )\end{matrix}$$

Here, N is an adjustable internal parameter (natural number). The variance value σ(i) corresponds to an estimation value with regard to temporal variation of wireless reception environment.

The interference threshold calculation unit 207 constitutes a second threshold calculation means or a third threshold calculation means, and calculates a detection threshold value Th2(i) by an equation (4) from the instantaneous interference power Iinst(i) outputted from the instantaneous interference power calculation unit 201 and the variance value of instantaneous interference power σ(i) outputted from the variance calculation unit 206, and outputs the calculated Th2(i) to the threshold comparison processing unit 208.

Th2(i)=C2−σ(i)−Iinst(i) (4)

Here, C2 is an adjustable internal parameter.

The threshold comparison processing unit 208 constitutes a comparison means and, using the detection threshold values Th0(0, Th1(i) and Th2(i) as input, outputs the largest one of the detection threshold values Th0, Th1 and Th2 to the level detection processing unit 209 as a detection threshold value Thmax(i). The level detection processing unit 209 constitutes a detection means and, with respect to the output from the cross-correlation calculation unit 200, compares the cross-correlation values with the detection threshold value Thmax(i) outputted from the threshold comparison processing unit 208, thereby determines a preamble sequence giving a cross-correlation value larger than the detection threshold value Thmax(i) to be “detected”, that is, to be detected as a received preamble sequence, and outputs the result to the wireless resource allocation device.

Here, the cross-correlation calculation unit 200, the instantaneous interference power calculation unit 201 and the interference power averaging processing unit 202 are well-known to those skilled in the art, and their configurations are not directly relevant to the present invention, and therefore, description of their detail configurations will be omitted here.

Next, a detection process will be described with reference to a flow chart shown in FIG. 2. In a step S11, using a received signal r(i) as input, the cross-correlation calculation unit 200 calculates cross correlation values between the received signal r(i) and respective ones of all preamble sequences possibly to be sent, In a step S12, the instantaneous interference power calculation unit 201 calculates an instantaneous interference power Iinst(i), using the received signal r(i) as input. In a step S13, the interference power averaging processing unit 202 updates an average interference power Iavg(i), using a previous average interference power Iavg(i−1) and the instantaneous interference power Iinst(i).

In a step S14, the detection threshold calculation unit 203 calculates a detection threshold value Th0(i) from the updated average interference power Iavg(i). In a step S15, the cross-correlation maximum calculation unit 204 selects a maximum value Pmax(i) from among the cross-correlation values with respect to respective ones of all preamble sequences possibly to be sent. In a step S16, the pass threshold value calculation unit 205 calculates a detection threshold value Th1(i) from the maximum cross-correlation value Pmax(i).

In a step S17, the variance calculation unit 206 stores variation of instantaneous interference power in the past N samples until a time i, and calculates a variance value of instantaneous interference power σ(i). In a step S18, the interference threshold calculation unit 207 calculates a detection threshold value Th2(i) from the instantaneous interference power Iinst (i) and the variance value of instantaneous interference power σ(i). In a step S19, the threshold comparison processing unit 208 calculates the largest one of the detection threshold values Th0(i), Th1(i) and Th2(i), and sets the largest value to be a detection threshold value Thmax(i). In a step S20, the level detection processing unit 209 compares the cross-correlation values with respect to the respective preamble sequences with the detection threshold value Thmax(i).

In a step S21, the level detection processing unit 209 determines whether any of the preamble sequences gives a cross-correlation value larger than the detection threshold value Thmax(i) or not. If it is determined in the step S21 that some one of the preamble sequences gives a cross-correlation value larger than the detection threshold value Thmax(i), the procedure proceeds to a step S22, where the level detection processing unit 209 determines that the preamble sequence has been detected as a received preamble sequence and outputs it to the wireless resource allocation device, and then the detection process is ended.

If it is determined in the step S21 that none of the preamble sequences gives a cross-correlation value larger than the detection threshold value Thmax(i), the procedure proceeds to a step S23, where the level detection processing unit 209 determines that no preamble sequence has been detected, and then the detection process is ended.

Next, a description will be given of operation of the preamble detection device in the reception conditions 1 and 2.

FIG. 3 is a diagram showing a relation between cross-correlation values and the detection threshold values in the reception condition 1. In FIG. 3, the horizontal axis represents preamble sequences, and the vertical axis does cross-correlation values.

In the case of the reception condition 1, that is, a case where the power of a preamble transmission signal of a terminal is high and attenuation of the signal during radio-wave propagation is small, output of the cross-correlation calculation unit 200 becomes very high when it corresponds to a cross-correlation value with respect to the preamble sequence sent by the terminal In that case, because the received power is high, cross-correlation values with respect to other preamble sequences also become relatively large. On the other hand, interference power shows almost no variation, and accordingly, variation of the detection threshold value Th0(i) also becomes very little. In contrast, the detection threshold value Th1(i) varies in accordance with a maximum of the cross-correlation values. Accordingly, in the reception condition 1, Th0(i)<Th1(i) stands between the two threshold values as shown in FIG. 3, and as a result, Th1(i) is selected as a finally determined detection threshold value Thmax(i). In that case, there occurs no false preamble detection in relation to preamble sequences other than the preamble sequence sent by the terminal. Thus, in the preamble detection device of the exemplary embodiment shown in FIG. 1, false preamble detection can be suppressed by adjusting the internal parameter C1 in a manner to make the cross-correlation values smaller than the detection threshold value Th1(i).

FIG. 4 is a diagram showing a relation between cross-correlation values and the detection threshold values in the reception condition 2. In FIG. 4, the horizontal axis represents time, and the vertical axis does output of the cross-correlation calculation unit 200 with respect to a certain preamble sequence.

Here, it is assumed that the instantaneous interference power Iinst(i) becomes extremely high at a time i_F. At that time, because the received power is high, the cross-correlation value also becomes large. The instantaneous interference power Iavg(i) shows smaller variation than the instantaneous interference power Iinst(i) does, by the effect of its being averaged in time, and accordingly, variation of the detection threshold value Th0(i) also becomes small. On the other hand, the detection threshold value Th2(i) varies in accordance with the instantaneous interference power Iinst(i). When variation of the interference power is large, a calculation result of the variance value of instantaneous interference power σ(i) becomes large, and also does a calculation result of the detection threshold value Th2(i). As a result, Th2(i) becomes likely to be selected as Thmax(i). That is, in the reception condition 2, a relation Th0(i)<Th2(i) stands between the detection threshold values as shown in FIG. 4, and Th2(i) is accordingly selected as a finally determined detection threshold value Thmax(i), and as a result, no false preamble detection occurs.

Thus, in the preamble detection device according to the present exemplary embodiment, false preamble detection can be suppressed by adjusting the internal parameter C2 in a manner to make the cross-correlation values smaller than the detection threshold value Th2(i). Further, it is possible to optimize adjustment of the internal parameter in accordance with temporal variation of interference signals by estimating the reception condition through σ(i).

As has been described above, the preamble detection device according to the present exemplary embodiment can suppress false preamble detection when preamble transmission power transmitted from a terminal is high and the amount of signal attenuation during radio-wave propagation is small, because the preamble detection device uses a threshold value calculated on the basis of cross-correlation values between a received signal and preamble sequences.

False preamble detection can be suppressed also when a high power interference signal is instantaneously received, because a threshold value calculated on the basis of instantaneous interference power is used. Further, an optimum parameter for suppressing false preamble detection can be calculated by estimating variation of the wireless reception condition through calculating variance of interference power.

Still further, because suppression of false preamble detection results in that the wireless resource allocation device in a wireless base station does not perform unnecessary wireless resource allocation, the efficiency of wireless resource utilization of the system can be increased.

FIG. 5 is a block diagram showing an example of a configuration of a preamble detection device according to a second exemplary embodiment of the present invention. This preamble detection device is different from that of the first exemplary embodiment shown in FIG. 1 in that this preamble detection device comprises a variance calculation unit 206A in place of the variance calculation unit 206, and in that the average interference power Iavg(i) outputted by the interference power averaging processing unit 202 is inputted to the variance calculation unit 206A in addition to the instantaneous interference power Iinst(i) outputted by the instantaneous interference power calculation unit 201.

In the equation (3) described in the first exemplary embodiment, the second term represents nothing but the average interference power. Accordingly, in the present exemplary embodiment, the average interference power Iavg(i) is used as input of the variance calculation unit 206A, and σ(i) is calculated by an equation (5).

$$\begin{matrix}[ numerical formula 2 ] & \\ σ ( i ) = \frac{1}{N} {\sum }_{n = 0}^{N - 1} {( Iinst ( i - n ) - Iavg ( i ) )}^{2} & ( 5 )\end{matrix}$$

According to the present exemplary embodiment, the processing amount of variance calculation can be reduced without deteriorating the function of suppressing false preamble detection.

In the exemplary embodiments described above, the configurations may be ones without the cross-correlation maximum calculation unit 204 and the pass threshold calculation unit 205. In that case, suppression of false preamble detection is impossible in the reception condition 1, but is possible in the reception condition 2.

The configurations may also be ones without the variance calculation unit 206 and the interference threshold calculation unit 207. In that case, suppression of false preamble detection is impossible in the reception condition 2, but is possible in the reception condition 1.

As has been described above, in a system in which a terminal sends a preamble sequence to a wireless base station by the use of a random access channel, by setting the wireless base station device to calculate a plurality of preamble detection threshold values, it becomes possible to suppress false preamble detection and accordingly to increase the efficiency of wireless resource utilization.

Suppression of false preamble detection is made possible by calculating a plurality of detection threshold values and performing threshold determination by the use of the largest one of the threshold values.

Thus, to a conventional configuration, added is a function of calculating another preamble detection threshold value in addition to that already used in the conventional configuration and then selecting the largest one of the plurality of detection threshold values. Cross-correlation values are calculated between a received signal and respective ones of all preamble sequences possibly to be sent, the detection threshold value Th1(i) is calculated from a maximum of the cross-correlation values, and then the threshold determination process is performed by the use of the larger one of the detection threshold values Th0(i) and Th1(i). By thus selecting a detection threshold value, false preamble detection can be suppressed when the reception condition 1 occurs.

Further, the detection threshold value Th2(i) is calculated from instantaneous interference power and variance of interference power, and then the threshold determination process is performed by the use of the larger one of the detection threshold values Th0(i) and Th2(i). By thus selecting a detection threshold value, false preamble detection can be suppressed when the reception condition 2 occurs.

By combining the above-described two processes such that the largest one of the detection threshold values Th0(i), Th1(i) and Th2(i) is used as a detection threshold value, false preamble detection can be suppressed in both of the reception conditions 1 and 2.

The sequence of processes described above may be executed either by hardware or by software. When the sequence of processes is executed by software, a program constituting the software is installed from a program recording medium into a computer comprised in dedicated hardware or into a general-purpose personal computer, for example, which can be enabled to perform various functions by installing various programs into the computer.

FIG. 6 is a block diagram of an example of a hardware configuration of a computer which executes the sequence of processes described above according to a program.

In the computer, a CPU (Central Processing Unit) 301, a ROM (Read Only Memory) 302 and a RAM (Random Access Memory) 303 are connected with each other via a bus 304.

To the bus 304, also connected is an input/output interface 305. To the input/output interface 305A, connected are an input unit 306 comprising various switches or the like, an output unit 307 comprising a display, a speaker and the like, a storage unit 308 comprising a hard disk, a nonvolatile memory or the like, a communication unit 309 comprising a network interface or the like, and a drive 310 which drives a removable media 311 being such as a magnetic disk, an optical disc, a magneto-optic disk and a semiconductor memory.

In the computer thus configured, the above-described sequence of processes is performed, for example, by the CPU 301 loading a program stored in the storage unit 308 into the RAM 303 via the input/output interface 305 and the bus 304 and then executing the program.

The program to be executed by the computer (the CPU 301) is provided, for example, by being recorded in a removable medium 311, which is a package medium composed of a magnetic disk (including a flexible disc), an optical disc (such as a CD-ROM (Compact Disc-Read Only Memory) and a DVD), a magneto-optic disk, a semiconductor memory or the like, or is provided via a wired or wireless transmission medium such as a local area network, the internet and digital satellite broadcasting.

Then, the program may be installed into the computer by loading the removable media 311 into the drive 310 and thereby storing the program into the storage unit 308 via the input/output interface 305. The program may be installed into the computer also by being received at the communication unit 309 via a wired or wireless transmission medium and then stored into the storage unit 308. As another way, the program may be installed in the computer in advance by being stored in advance in the ROM 302 or the storage unit 308.

Here, the program executed by the computer may be a program for performing processes in a temporal sequence according to the order described in the present description, and may also be a program for performing processes in parallel or at a time the processes need to be performed such as when they are called.

By changing sequences used in the cross-correlation calculation unit 200, the present invention can be applied also to a process of detecting a scheduling request (SR) signal sent from a terminal by the use of a physical uplink control channel (PUCCH), which is performed at a wireless base station. Also possible is application to a process of detecting an ACK/NACK (ACKnowledge/Negative ACKnowledge) feedback signal sent from a terminal by the use of a physical uplink shared channel (PUSCH), which is performed at a wireless base station. Further, the present invention can be used for preamble detection not only at a wireless base station but also at a terminal.

Exemplary embodiments of the present invention are not limited to those described above, and various changes may be made within a range not departing from the spirit of the present invention. This application is based upon and claims the benefit of priority from Japanese patent application No. 2012-146024, filed on Jun. 28, 2012, the disclosure of which is incorporated herein in its entirety by reference.

### REFERENCE SIGNS LIST

200 . . . cross-correlation calculation unit,
201 . . . instantaneous interference power calculation unit,
202 . . . interference power averaging processing unit,
203 . . . detection threshold calculation unit (first threshold calculation means),
204 . . . cross-correlation maximum calculation unit,
205 . . . pass threshold calculation unit (second threshold calculation means),
206, 206A . . . variance calculation unit,
207 . . . interference threshold calculation unit (second threshold calculation means or third threshold calculation means),
208 . . . threshold comparison processing unit (comparison means),
209 . . . level detection processing unit (detection means),
301 . . . CPU,
302 . . . ROM,
303 . . . RAM,
308 . . . storage unit,
309 . . . communication unit,
311 . . . removable medium.

1. A preamble detection device that detects a preamble sequence sent by the use of a physical random access channel, the preamble detection device comprising:
a first threshold calculation unit that calculates a first threshold value from average interference power;
a second threshold calculation unit that calculates cross-correlation values between a received signal and respective ones of all preamble sequences possibly to be sent, and calculating a second threshold value from the cross-correlation values;
a comparison unit that compares the first threshold value with the second threshold value, and setting the larger one of the threshold values to be a detection threshold value; and
a detection unit that detects a preamble sequence giving a cross-correlation value larger than the detection threshold value as a received preamble sequence.

2. The preamble detection device according to claim 1, further comprising
a third threshold calculation unit that calculates a third threshold value from instantaneous interference power and variance of interference power, wherein
the comparison unit compares the first threshold value, the second threshold value and the third threshold value, and sets the largest one of the threshold values to be the detection threshold value.

3. A preamble detection method for detecting a preamble sequence sent by the use of a physical random access channel, the preamble detection method comprising:
a step of calculating a first threshold value from average interference power;
a step of calculating cross-correlation values between a received signal and respective ones of all preamble sequences possibly to be sent, and calculating a second threshold value from the cross-correlation values;
a step of comparing the first threshold value with the second threshold value, and setting the larger one of the threshold values to be a detection threshold value; and
a step of detecting a preamble sequence giving a cross-correlation value larger than the detection threshold value as a received preamble sequence.

4. (canceled)

5. A preamble detection device that detects a preamble sequence sent by the use of a physical random access channel, the preamble detection device comprising:
a first threshold calculation unit that calculates a first threshold value from average interference power;
a second threshold calculation unit that calculates a second threshold value from instantaneous interference power and variance of interference power;
a comparison unit that compares the first threshold value with the second threshold value, and setting the larger one of the threshold values to be a detection threshold value; and
a detection unit that detects a preamble sequence giving a cross-correlation value larger than the detection threshold value as a received preamble sequence.

6-7. (canceled)
